(19) United States
(12) Patent Application Publication
(10) Pub. No.: US 2016/0371682 A1
(43) Pub. Date: Dec. 22, 2016

(54) SYSTEMS AND METHODS FOR PROVIDING VARIABLE FEE RATES FOR PROCESSING A TRANSACTION

(71) Applicant: Wells Fargo Bank,N.A., San Francisco, CA (US)

(72) Inventors: Philip Sprague, San Francisco, CA (US); Daniel David, San Francisco, CA (US)

(73) Assignee: WELLS FARGO BANK, N.A., San Francisco, CA (US)

(21) Appl. No.: 14/745,258

(22) Filed: Jun. 19, 2015

(51) Int. Cl. G06Q 20/38; G06Q 20/10; G06Q 20/22

(52) U.S. Cl. CPC G06Q 20/387; G06Q 20/227; G06Q 20/102

(57) ABSTRACT

A method for incentivizing a payment method includes providing a first fee rate for processing a payment to a payee from a payer, wherein the first fee rate is contingent upon use of a first payment method, and a second fee rate for processing the payment, wherein the second fee rate is contingent upon use of the first payment method and includes an incentive amount based on the difference between the second fee rate and the first fee rate. The method also includes receiving a selection of the second fee rate and, based on the selection, providing an incentive offer to an account holder, wherein the incentive offer is redeemable upon use of the first payment method to initiate the payment, and wherein the value of the incentive offer is based at least in part on the incentive amount.

### BACKGROUND

A merchant discount rate is a fee paid by a merchant for processing a transaction. For example, in a typical payment card transaction, a cardholder presents a payment card (e.g., debit card, credit card, etc.) to a merchant for payment. The merchant may then submit the transaction to an acquiring financial institution (i.e., an acquiring bank, or acquirer) that is associated with the merchant for authorization of the payment. The acquirer sends payment information to the financial institution responsible for issuing the payment card (i.e., an issuing bank, or issuer) in order to request approval of the transaction. The merchant may be charged a merchant discount rate in exchange for processing the transaction (i.e., approving and transferring the payment amount) on behalf of the merchant.

The merchant discount rate for a payment card transaction may include various processing and other fees that are collected by the parties to the transaction, including any of the issuing bank, the acquiring bank, the credit card network, a payment processor, and so on. For example, for a Visa card transaction, the merchant discount rate is determined based at least in part on the rules and fees associated with the Visa card network. As part of belonging to the Visa card network, issuing banks and acquiring banks agree that the fees exchanged (i.e., the fee paid by the acquiring bank to the issuing bank) will be determined according to the rules of the Visa card network. Pursuant to such rules, the merchant discount rate is determined based on the characteristics of the transaction, including the amount of the transaction, the type of transaction (e.g., whether the transaction is a card present or card not present transaction), and other factors. The merchant discount rate, including the various processing and other fees charged by each of the parties to the transaction, may be charged to the merchant by the acquirer in exchange for processing the transaction. In addition to credit card and debit card transactions, merchant discount rates (or other processing fees) may also be charged in the context of other types of transactions using other payment mechanisms.

### SUMMARY

One embodiment of the present disclosure relates to a computer-implemented method performed by one or more processors of a payee financial institution computer system. The method includes providing to a merchant computer system, by the payee financial institution computer system, a first fee rate for processing a payment to a payee from a payer, wherein the payee is a merchant, and wherein the first fee rate is contingent upon use of a first payment method by the payer to initiate the payment. The method also includes providing to the merchant computer system, by the payee financial institution computer system, a second fee rate for processing the payment, wherein the second fee rate is contingent upon use of a second payment method by the payer to initiate the payment, and wherein the second fee rate is greater than the first fee rate. The method also includes providing to the merchant computer system, by the payee financial institution computer system, a third fee rate for processing the payment, wherein the third fee rate is contingent upon use of the first payment method by the payer to initiate the payment, wherein the third fee rate is greater than the first fee rate and less than the second fee rate, and wherein the third fee rate includes an incentive amount based on the difference between the third fee rate and the first fee rate. The method further includes, based on a selection of the third fee rate by the merchant computer system, providing, by the payee financial institution computer system, an incentive offer to the payer, wherein the incentive offer is redeemable upon use of the first payment method by the payer in a payment transaction with the merchant, and wherein the value of the incentive offer is based at least in part on the incentive amount.

Another embodiment of the present disclosure relates to a computer-implemented method performed by one or more processors of a payee financial institution computer system. The method includes providing to a merchant computer system, by the payee financial institution computer system, a first fee rate for processing a payment to a payee from a payer in exchange for a first level of data associated with the payment, wherein the payee is a merchant, providing to the merchant computer system, by the payee financial institution computer system, a second fee rate for processing the payment in exchange for a second level of data associated with the payment, wherein the second level of data includes additional information not included within the first level of data, receiving, by the payee financial institution computer system, a selection of one of the fee rates from the merchant computer system, and processing, by the payee financial institution computer system, the payment in accordance with the selected fee rate, including receiving the level of data associated with the selected fee rate.

Another embodiment of the present disclosure relates to a computer-implemented method performed by one or more processors of a payee financial institution computer system. The method includes providing to a merchant computer system, by the payee financial institution computer system, a first fee rate for processing a payment to a payee from a payer, wherein the payee is a merchant, and wherein the first fee rate is contingent upon use of a first payment method by the payer to initiate the payment. The method also includes providing to the merchant computer system, by the payee financial institution computer system, a second fee rate for processing the payment, wherein the second fee rate is contingent upon use of the first payment method by the payer to initiate the payment, and wherein the second fee rate includes an incentive amount that is approximately equal to the difference between the second fee rate and the first fee rate. The method further includes receiving, by the payee financial institution computer system, a selection of the second fee rate from the merchant computer system, and, based on the selection, providing, by the payee financial institution computer system, an incentive offer to the payer, wherein the incentive offer is redeemable upon use of the first payment method by the payer to initiate the payment, and wherein the value of the incentive offer is based at least in part on the incentive amount.

Another embodiment of the present disclosure relates to a computer-implemented method performed by one or more processors of a payee financial institution computer system. The method includes providing to a merchant computer system, by the payee financial institution computer system, a first fee rate for processing a payment to a payee from a payer, wherein the payee is a merchant, and wherein selection of the first fee rate guarantees deposit of the payment from a payment account of the payer to an account of the merchant within a first time period. The method also includes providing to the merchant computer system, by the payee financial institution computer system, a second fee rate for processing the payment to the payee from the payer, wherein selection of the second fee rate guarantees deposit of the payment to the account of the merchant within a second time period, wherein the second time period is less than the first time period, and wherein the second fee rate is greater than the first fee rate. The method further includes receiving, by the payee financial institution computer system, a selection of one of the fee rates from the merchant computer system, and processing, by the payee financial institution computer system, the payment in accordance with the selected fee rate.

### BRIEF DESCRIPTION OF THE FIGURES

The details of one or more implementations are set forth in the accompanying drawings and the description below. Other features, aspects, and advantages of the disclosure will become apparent from the description, the drawings, and the claims, in which:

FIG. 1 is a schematic diagram of a payment processing system, according to an example embodiment.

FIG. 2 is a schematic diagram of a payment process that may be implemented using the system shown in FIG. 1 to process a payment to a merchant, according to an example embodiment.

FIG. 3 is a flow chart diagram of a payment process that may be implemented using the system shown in FIG. 1 to incentivize expedited payment to a merchant, according to an example embodiment.

FIG. 4 is a flow chart diagram of a payment process that may be implemented using the system shown in FIG. 1 to incentivize utilization of a particular payment type, according to an example embodiment.

FIG. 5 is a flow chart diagram of payment process that may be implemented using the system shown in FIG. 1 to incentivize providing enhanced transaction detail, according to an example embodiment.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting.

Referring generally to the FIGURES, a payment processing system 100 is shown which may be used to process a payment to a merchant from a payee (i.e., an account holder) having a payment account provided by a payer financial institution (e.g., an issuing bank, a payment service provider, etc.). After the payment is initiated by the customer (i.e., the account holder), the payer financial institution pays the amounts owed to a payee financial institution (e.g., an acquiring bank, a payment processor, an aggregator, etc.) that processes the payment on behalf of the merchant. The payee financial institution may charge a fee (i.e., a “merchant discount rate”) to the merchant in exchange for processing the transaction. The merchant discount rate may include any number of processing and other fees that are collected by the payer financial institution, the payee financial institution, and/or any other party in exchange for processing the transaction. Herein, many of the examples involve credit card and debit card transactions and, hence, for simplicity, the payer financial institution may be referred to as an issuing bank and the payee financial institution may be referred to as an acquiring bank. However, as will become apparent below, other payment mechanisms may also be used, and hence the payer financial institution need not be an issuing bank and the payee financial institution need not be an acquiring bank.

The payment processing system 100 may be used to provide variable fee rates (i.e., merchant discount rates) to be charged to the merchant in exchange for processing a payment from the account holder. The variable fee rates may be varied based on one or more benefits to be provided to the merchant, the account holder, or another party as part of processing the transaction. In an example embodiment, the variable fee rates are used to incentivize use of a particular type of payment account (i.e., a preferred payment account) by an account holder. For instance, the variable fee rate may include an additional amount (i.e., an incentive) which is paid by the merchant and provided to the account holder (e.g., via the issuing bank, via the merchant, etc.) when the preferred payment account is used to make a payment to the merchant. Variable fee rates may also be used to provide the merchant with options to assist the merchant in management of its cash flow. For example, the fee rate paid by the merchant may be increased in exchange for faster payment of the amounts owed to the merchant. As another example, variable fee rates may be used to incentivize the merchant to provide enhanced transaction detail. In other examples and embodiments, many of which are described below in further detail, the payment processing system 100 may be used to provide variable fee rates for processing a payment based on any number of factors related to the payment and/or the parties involved in the transaction.

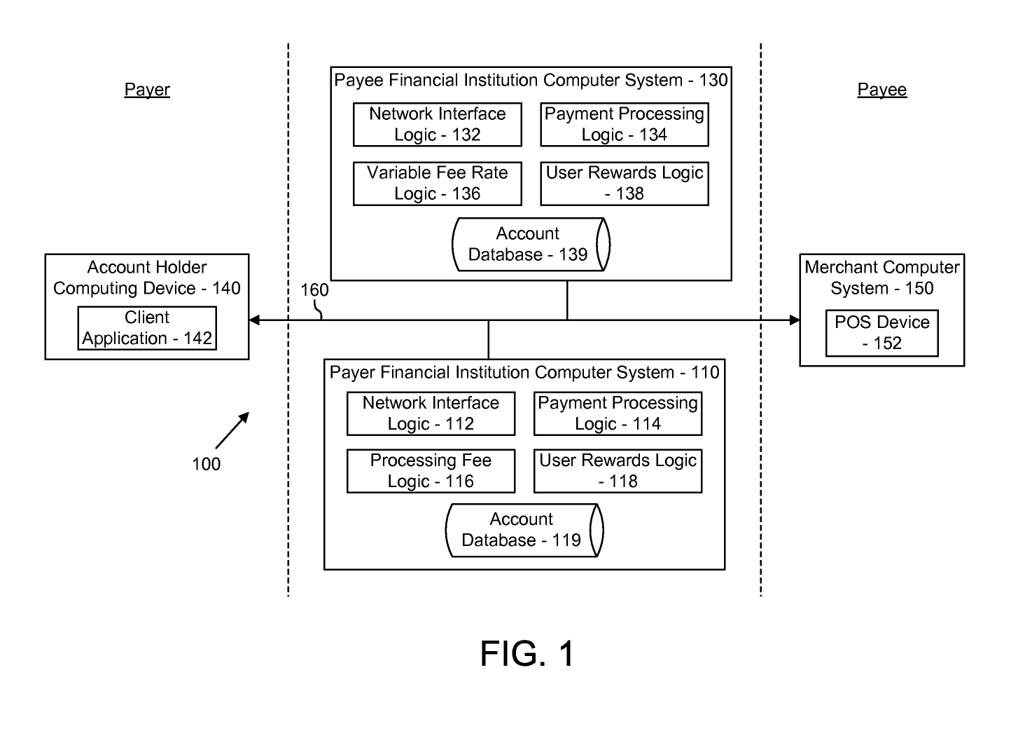

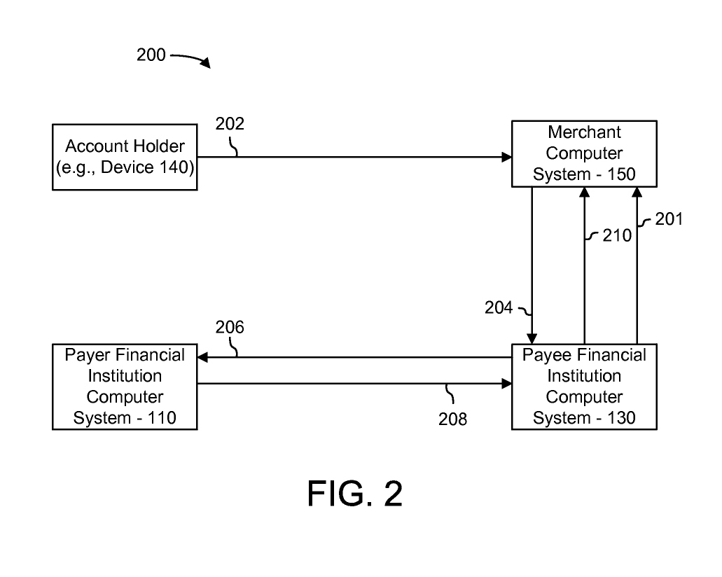

Referring to FIG. 1, the payment processing system 100 is shown to include a payer financial institution computer system 110, a payee financial institution computer system 130, an account holder computing device 140, and a merchant computer system 150. The payer financial institution computer system 110, the payee financial institution computer system 130, the account holder computing device 140, and the merchant computer system 150 may communicate through a network 160, which may include one or more of the Internet, cellular network, Wi-Fi, Wi-Max, a proprietary banking network, and so on. The payer financial institution computer system 110, the payee financial institution computer system 130, the account holder computing device 140, and the merchant computer system 150 may each include a computer system configured to execute instructions, send and receive data stored in memory, and perform other operations to implement the operations described herein associated with logic or processes shown in FIGS. 2 through 5. For instance, the account holder computing device 140 may include a mobile device or other computing device that is operated by a user having a payment account held by the payer financial institution computer system 110 and configured to communicate with one or more of the other systems. Similarly, the merchant computer system 150 may include a merchant point of sale (POS) device or other merchant computer system held by a merchant associated with the payment processing system 100.

The payer financial institution computer system 110, the payee financial institution computer system 130, the account holder computing device 140, and the merchant computer system 150 may each include one or more processors and memory. The one or more processors may be implemented as application specific integrated circuits (ASICs), one or more field programmable gate arrays (FPGAs), a group of processing components, or other suitable electronic processing components. The memory may be one or more devices (e.g., RAM, ROM, Flash memory, hard disk storage, etc.) for storing data and/or computer code for completing and/or facilitating the various processes described herein. The memory may be or include non-transient volatile memory, non-volatile memory, and non-transitory computer storage media. The memory may include data base components, object code components, script components, or any other type of information structure for supporting the various activities and information structures described herein. The memory may be communicably connected to the processor and include computer code or instructions for executing one or more processes described herein.

The payer financial institution computer system 110 is operated by a financial institution (i.e., a payer financial institution) that facilitates payments from a payment account held by the account holder (i.e., the payer, the customer, etc.) in connection with the payment processing system 100. The payer financial institution may include any entity that is able to process a payment transaction on behalf of the payer, including a depositary financial institution (e.g., a bank or credit union), a credit account provider (e.g., a credit card company, a merchant, etc.), and/or a payment service provider. The payment account may include a demand deposit account (e.g., checking account), a credit card account, another line of credit, digital currency (e.g., bitcoin), an XRP (i.e., Ripple payment protocol) payment account, a payment account provided by a payment service provider, and/or any other account that may be utilized to make a payment to a merchant. The payment account may be issued (e.g., hosted) by the payer financial institution computer system 110. The payment account may also include an account that is provided by the payer financial institution computer system 110 in order to facilitate payments from another source account issued by another financial institution.

The payer financial institution computer system 110 is configured to process (e.g., approve, authorize, etc.) payment transactions associated with the payment account in exchange for a processing fee (i.e., an interchange fee). For instance, the payer financial institution computer system 110 may authenticate payment information received from the account holder and transfer the payment amount from the payment account of the account holder to the payee financial institution computer system 130. The processing fee paid to the payer financial institution computer system 110 may be included as part of the merchant discount rate (i.e., the variable fee rate) that is charged to the merchant by the payee financial institution computer system 130. Thus, the processing fee paid to the payer financial institution computer system 110 may be paid by the merchant.

The payer financial institution computer system 110 includes network interface logic 112, payment processing logic 114, processing fee logic 116, and user rewards logic 118. Such logic may be implemented in a machine (e.g., one or more networked computer servers) comprising machine-readable media having instructions stored therein which are executed by the machine to perform the operations described herein. The network interface logic 112 may include, for example, program logic that communicatively connects the payer financial institution computer system 110 to the network 160. The network interface logic 112 may be configured to enable the payer financial institution computer system 110 to send or receive messages from any of the account holder computing device 140, the merchant computer system 150, and the payee financial institution computer system 130, including having communications logic specific to each of the computer systems.

The payment processing logic 114 may be executed by the payer financial institution computer system 110 to process a payment on behalf of the account holder, including processing a payment from a payment account held by the account holder and maintained by the payer financial institution computer system 110. For instance, the payer financial institution computer system 110 may receive a request from the payee financial institution computer system 130 to process a payment from the account holder. The request may include information related to the payment, including identifying information for the account holder and the associated payment account. The payment processing logic 114 is configured to process the payment based on the request, which may include authenticating the request and approving the payment based on the information received. The payment processing logic 114 is configured to process the payment in exchange for a processing fee, which may be received from the payee financial institution computer system 130 (e.g., via the merchant).

The processing fee logic 116 may be executed by the payer financial institution computer system 110 to determine a processing fee (i.e., an interchange fee) to be charged to the payee financial institution (or another entity) for processing a payment to the merchant. In the case of a credit card transaction, for example, the fee may be determined based on the characteristics of the transaction, including the amount of the transaction, the type of transaction (e.g., whether the transaction is a card present or card not present transaction), and other factors.

The user rewards logic 118 may be executed to generate user rewards for the account holder. The user rewards may be related to an incentive provided to the account holder as part of the system 100. For instance, user rewards may be offered to the account holder in order to incentivize use of a particular payment account (or payment method) to make a payment to the merchant. Information about the user rewards may be provided to the account holder from the payer financial institution computer system 110 when the payment is processed. The user rewards may be any of rewards points, discounts, promotions, offers, or any other rewards that may be provided to the account holder by the payer financial institution computer system 110.

The payer financial institution computer system 110 also includes accounts database 119. The accounts database 119 may store information regarding payment accounts held by the account holder, as well as other payment accounts provided and maintained by the payer financial institution computer system 110. The information stored within the accounts database 119 may be used to determine the processing fee for a particular payment. The information may also be utilized by the user rewards logic 118 to generate account-specific user rewards for incentivizing certain payment methods.

The payee financial institution computer system 130 is operated by a financial institution having a relationship with the merchant. The payee financial institution computer system 130 is configured to process the transaction between the account holder and the merchant on behalf of the merchant. For instance, the payee financial institution may be an acquiring bank. In various embodiments, the payee financial institution computer system 130 may include a payment processor or aggregator affiliated with the payee financial institution computer system 130, any of which may perform the tasks described herein as being performed by the payee financial institution computer system 130. The payee financial institution computer system 130 includes network interface logic 132, payment processing logic 134, variable fee rate logic 136, user rewards logic 138 and account database 139. The network interface logic 132 may operate in generally the same manner as the network interface logic 112.

The payment processing logic 134 may be executed to process payments on behalf of the merchant. The payment processing logic 134 receives payment authorization requests, including various payment information, from the merchant computer system 150. The payment processing logic 134 may route the authorization requests to the appropriate financial institution (e.g., payer financial institution computer system 110) based on the payment information. The payee financial institution computer system 130 may provide and maintain an account for the merchant. When the payment is authorized by the payer financial institution computer system 110, the payment processing logic 134 may receive funds from the payer financial institution computer system 110 on behalf of the merchant and deposit the funds in the merchant account. The payment processing logic 134 may also pay the processing fee charged by the payer financial institution computer system 110 to process the payment. The payee financial institution computer system 130 may deduct the processing fee from the amount deposited in the merchant account. For instance, the processing fee may be included as part of the fee (i.e., the merchant discount rate) charged to the merchant by the payee financial institution computer system 130.

The variable fee rate logic 136 may be executed to determine variable fee rates (i.e., the merchant discount rate) associated with processing a particular payment on behalf of the merchant. The associated fee is charged to the merchant to process a payment to the merchant using the payment processing system 100. The merchant discount rate may include a processing fee charged by the payer financial institution computer system 110 (i.e., the interchange fee), by the payee financial institution computer system 130, by a card network associated with the payment account (i.e., a network fee), and any other fees or surcharges associated with processing the payment. The variable fee rates (i.e., the merchant discount rates) may be determined based on one or more parameters associated with a particular payment, including the type of payment account used, the amount of the payment, and any other payment-specific information.

In some embodiments, the variable fee rate logic 136 generates variable fee rates that vary from what would otherwise be required in the context of a particular transaction. For example, in the context of a credit card transaction, the variable fee rate logic 136 may determine variable fee rates that are different than those required by the rules of the payer financial institution computer system 110, the payee financial institution computer system 130, and/or an associated card network. In an example embodiment, the variable fee rate logic 136 is configured to vary the merchant discount rate (i.e., the variable fee rate) by modifying the processing fee charged by the payee financial institution computer system 130, with all other portions of the merchant discount rate being determined by another entity or remaining relatively static. The variable fee rates may be generated to incentivize certain behavior or to provide other benefits to the merchant and/or the account holder. The merchant may be provided with the variable fee rates and be permitted to select one of the rates in order to receive the associated benefits.

In one embodiment, the variable fee rate logic 136 generates a range of variable fee rates based on a guaranteed processing speed for the payment (e.g., the time between when the payment is initiated by the account holder and the associated funds are deposited in a merchant account). For instance, the merchant may be provided with a range of variable fee rates that includes higher fee rates for processing the payment within a shorter time period. The fee rate may include a guarantee that the payment amount will be deposited within an account of the merchant within a specific time period. The payee financial institution computer system 130 is configured to receive a selection of one of the variable fee rates from the merchant computer system 150 and process the payment according to the selection. For example, in exchange for a greater fee rate paid by the merchant computer system 150, the payee financial institution computer system 130 may advance the payment to the merchant computer system 150 (i.e., deposit the payment amount in an account of the merchant) prior to receiving payment from the payer financial institution computer system 110.

The variable fee rate logic 136 may also be configured to generate variable fee rates in order to incentivize certain behaviors of the account holder. For instance, the generated fee rates for a particular payment may vary depending on the payment method (e.g., type of payment account, payment location, merchant location, etc.) used by the account holder. As an example, the merchant discount rate for a particular payment may vary depending on whether the account holder uses a credit card, debit card, ACH transaction, and so on. The variation in the fee rate may be based on a cost to the payee financial institution computer system 130 (or another entity) for processing the payment using that payment method. The variable fee rate logic 136 may be executed to modify a merchant discount rate associated with a preferred payment method (i.e., preferred by the merchant) to include an additional amount (i.e., an incentive amount). The additional amount charged to the merchant by the payee financial institution computer system 130 may then be used to offer an incentive to the account holder for using of the preferred payment method to make a payment. The incentive may be based on the additional amount charged to the merchant. For example, if the merchant discount rate for a debit transaction is typically $0.50 per transaction and the merchant discount rate for an ACH transaction is typically $0.25 per transaction, the merchant may be provided with the option to be charged a merchant discount rate of $0.40 per ACH transaction, with at least a portion of the $0.15 surcharge being used to by the payee financial institution computer system 130 to provide an incentive to the account holder to use ACH as a payment method instead of a debit card. The payee financial institution computer system 130 may also offer an incentive having a value greater than $0.15, such as when the preferred payment method provides an additional incentive (e.g., a lower cost) to the payee financial institution computer system 130 (or another entity within system 100). The variable fee rates, including any incentive amount, may be specified as a percentage of the transaction, as a dollar amount, or in another manner. As another example, the variable fee rates may be used in a similar manner to incentivize the merchant to provide enhanced transaction detail related to the payment.

The user rewards logic 138 may be executed to generate user rewards for the account holder. In an example embodiment, the merchant discount rate may be adjusted to provide an incentive amount based on a preferred payment method of the merchant. The user rewards logic 138 is configured to determine user rewards for the account holder having a value of at least a portion of the incentive amount. The user rewards may then be sent to the account holder from the payee financial institution computer system 130 when the payment is processed. The user rewards may be any of rewards points, discounts, cash back, promotions, offers, or any other rewards that may be provided to the account holder by the payee financial institution computer system 130. The user rewards may be provided to the account holder via the payer financial institution, the merchant, or directly.

The account holder computing device 140 may be, for example, a handheld computer, a cellular phone, smart phone, mobile handheld wireless e-mail device, personal digital assistant, portable gaming device, or other suitable device. In some embodiments (e.g., in the context of online transactions), the device 140 may be a laptop computer, desktop computer, or like device. In some embodiments, the device 140 may include a client application 142. For example, the client application 142 may be a program or other application that is provided by the merchant computer system 150. As another example, the application may a mobile banking or mobile wallet application provided by the payer financial institution computer system 110. The client application (or circuit) 142 may include program logic executable by the device 140 to implement at least some of the functions described herein as being performed by the device 140. In order to make the circuit 142, the one or more of the computer systems 110, 130, 150 may provide a software application and make the software application available to be placed on the device 140. For example, the software application may be made available to be downloaded (e.g., via a website, via an app store, or in another manner). Responsive to a user selection of an appropriate link, the application may be transmitted to the device 140 and may cause itself to be installed on the device 140. Installation of the software application creates the circuit 142 on the device 140. Specifically, after installation, the thus-modified device 140 includes the circuit 142 (embodied as a processor and instructions stored in non-transitory memory that are executed by the processor).

The merchant computer system 150 may include an enterprise computing system as well as an individual point-of-sale (POS) device 152 (e.g., terminal). As previously indicated, in some embodiments, the merchant is provided with the option to select from a plurality of variable fee rate options. The selection may occur well in advance of the instant at which a particular transaction is performed. For example, the selection may be made for all transactions occurring within a given time period (e.g., from the time at which the selection is made, and continuing for days/weeks/months until a different selection is made). Any cost savings or other incentives may then be provided to the account holder by the POS terminal (i.e., device 152) or in another manner. In other embodiments, the selection may occur on a transaction-by-transaction basis.

The merchant computer system 150 may also establish communications with the account holder computing device 140 (e.g., prior to the time of purchase). For example, as previously indicated, the merchant computer system 150 may provide an in-store application (e.g., client application 142) that may be executed on the account holder computing device 140. For example, the in-store application may utilize wireless low energy beacons (e.g., Apple iBeacons) located throughout the store to provide the account holder with information about merchandise, special promotions, and so on. For example, an account holder standing in front of a new television that is part of a clearance sale at a consumer electronics store and who is considering purchasing the new television may be sent a text message via the device 140 such as “Special Promotion: Pay for this television now using your demand deposit account and receive an additional $50 off the purchase price!”.

Referring now to FIG. 2, a process 200 is shown for processing a payment, according to an example embodiment. The process 200 may be used to process a payment received by the merchant computer system 150 from the account holder using a payment account provided (or otherwise facilitated) by the payer financial institution computer system 110. The process 200 may be performed using the payment processing system 100 shown in FIG. 1. With regard to the process 200, any steps referring to the merchant computer system 150 may also be performed by the payee financial institution computer system 130 acting on behalf of the merchant computer system 150. It should also be noted that any steps referring to the payee financial institution computer system 130 may also be performed by a payment processor or aggregator, either individually or as part of the payee financial institution computer system 130.

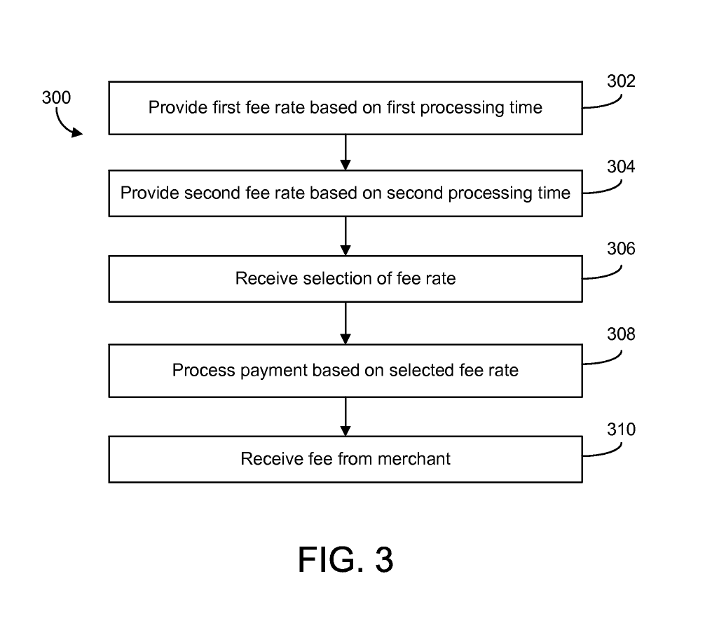

At step 201, the payee financial institution computer system 130 provides the merchant computer system 150 with selectable variable fee rates (i.e., merchant discount rate) for processing a payment. The variable fee rate is intended to be charged to the merchant in exchange for processing a payment from a payer (e.g., the account holder). The variable fee rates may vary from what would otherwise be required in the context of a particular transaction. For instance, the variable fee rates may be generated and used to incentivize certain behavior by the account holder, or to provide other benefits to the merchant and/or the account holder. More detailed examples of the types of variable fee rates that may be provided are discussed below in connection with FIGS. 3-5. As previously indicated, the merchant may select a variable fee rate in advance of a particular transaction. The merchant may also select a variable fee rate on a transaction-by-transaction basis. (Hence, although step 201 is depicted as the first step, step 201 may in practice be performed after other steps shown in FIG. 2 have been performed. As elsewhere in the FIGURES, while operations are depicted in a particular order, this should not be understood as requiring that such operations be performed in the particular order shown or in sequential order.)

At 202, the account holder provides payment information to the merchant computer system 150. In one embodiment, the merchant is a brick and mortar merchant that includes a merchant point of sale (POS) device 152. In this embodiment, the account holder may provide a payment card to the merchant POS device 152 to initiate payment. The merchant POS device 152 may record information related to a payment account of the account holder based on the payment card. The account holder may also utilize a mobile device such as device 140 (e.g., smart phone, tablet, smart watch, NFC card, etc.) that is configured to provide payment information to a merchant POS device 152. For instance, the account holder may provide a barcode, NFC transmission, or otherwise electronically transmit payment information to the merchant POS device 152. The account holder may also provide biometric data as payment information, or authenticate the account holder via facial recognition technology. In another embodiment, the merchant computer system 150 provides a retail website or other online marketplace. In this embodiment, the account holder provides payment information via the online marketplace and the payment information is received at the merchant computer system 150.

In still other embodiments, the payment information may be received from the account holder at the payer financial institution computer system 110 to initiate a payment to the merchant. For instance, the account holder may initiate a payment by sending a message to the payer financial institution computer system 110 using the client application 142 stored on the account holder computing device 140. The account holder may also register the merchant with the payer financial institution computer system 110 to receive an electronic payment, such as a recurring bill payment. The payment may then be initiated or otherwise approved by the account holder via a communication from the account holder to the payer financial institution computer system 110.

At 204, the merchant computer system 150 sends the payment information to the payee financial institution computer system 130 to process the payment on behalf of the merchant. The payment information may include details related to the payment, such as a payment amount, a time stamp for the transaction, location information, and other identifying details. The payment information may also include account information for the payment account, including the method of payment (e.g., online, in-store, etc.), which may also include a type of payment account (e.g., credit card, demand deposit, line of credit, etc.). The payment information may also include identifying information for the payer financial institution, including contact information for use in processing the payment.

At 206, the payee financial institution computer system 130 sends a message to the payer financial institution computer system 110 requesting the payer financial institution computer system 110 to process the payment on behalf of the account holder. The message may include a request for the payer financial institution computer system 110 to authorize (e.g., authenticate, approve, etc.) the payment transaction on behalf of the account holder. The message may include at least a portion of the payment information so that the payer financial institution computer system 110 may identify the account holder and/or the payment account. The payer financial institution computer system 110 may determine and/or request a processing fee in response to receiving the request. The processing fee may be determined by the payer financial institution computer system 110 based on the details of the payment. The processing fee may be included as part of the variable fee rate charged to the merchant (i.e., the merchant discount rate).

At 208, the payer financial institution computer system 110 processes the payment on behalf of the account holder and sends the payment amount to the payee financial institution computer system 130. The payment may be processed by comparing information from the authorization request to information stored in the accounts database 119. The payer financial institution computer system 110 may receive a processing fee in exchange for processing the payment. For instance, the payer financial institution computer system 110 may deduct the processing fee from the payment amount and transmit the difference to the payee financial institution computer system 130. Alternatively, the processing fee for the payment may be paid to the payer financial institution computer system 110 in a separate transaction. In one embodiment, processing fees are account for at the time of the transaction, then paid to the payer financial institution computer system 110 in batches (e.g., once per day, after a number of transactions, etc.).

At 210, the payee financial institution computer system 130 deposits the payment amount (or another amount) in an account held by the merchant. The merchant account may be provided by the payee financial institution computer system 130. The merchant account may also be separately held by the merchant computer system 150, such that the payment amount is sent to the merchant computer system 150 by the payee financial institution computer system 130. The payee financial institution computer system 130 may deduct the merchant discount rate (i.e., the variable fee rate) from the payment amount prior to deposit. As described in further detail above, the merchant discount rate may include any incentive amount, as well any processing or other fees associated with the payment transaction. In some embodiments, upon completing the transaction, the payee financial institution computer system 130 and/or the merchant computer system 150 may also communicate information regarding associated user rewards (e.g., rewards points, discounts, promotions, offers, etc.) and/or other information related to the transaction to the account holder computing device 140.

Referring now to FIGS. 3-5, processes 300, 400, and 500 are shown for determining (e.g., generating, calculating, providing, etc.) variable fee rates for processing a transaction, according to various example embodiments. The processes 300, 400, and 500 may be performed using the payment processing system 100 shown in FIG. 1. In particular, the processes 300, 400, and 500 may be performed by the payee financial institution computer system 130, including any logic or other components of the payee financial institution computer system 130 which are described in further detail herein. Further, any steps referring to the merchant computer system 150 may also be performed by the payee financial institution computer system 130 acting on behalf of the merchant.

According to the process 300 of FIG. 3, the merchant is provided with the option to pay a higher fee rate (i.e., merchant discount rate) for processing a transaction in order to receive faster payment. For instance, in exchange for a higher fee rate, the payee financial institution may guarantee deposit of the payment amount (or another amount owed to the merchant) in an account of the merchant within a specified time period (e.g., within one minute, one hour, one day, etc.). As another example, the payee financial institution, in exchange for a higher fee rate, could guarantee deposit of the funds before the payee financial institution receives any funds from the payer financial institution.

At 302, a first fee rate (e.g., first merchant discount rate) is provided to the merchant computer system 150. The first fee rate may be generated by the payee financial institution computer system 130. The first fee rate is charged to the merchant by the payee financial institution computer system 130 in exchange for processing a payment to the merchant, including delivering the payment amount to the merchant (e.g., depositing the payment amount in an account of the merchant) within a first time period. In some embodiments, the first time period may be dictated by standard processing of the transaction pursuant to the processes/procedures of the entities associated with the payment (e.g., an issuing bank, an acquiring bank, a card network, a payment processor, an aggregator, a payment service provider, etc.). For instance, the first time period may be a sum of the processing time required by each entity to process the transaction. In these embodiments, the first fee rate may be the amount determined pursuant to the rules of the various entities, given the parameters of the particular transaction. For instance, the first fee rate may be equal or in proportion to the amount charged by the entities other than the payee financial institution computer system 130 to process the payment.

At 304, a second fee rate (e.g., second merchant discount rate) is provided to the merchant computer system 150. The second fee rate may be generated by the payee financial institution computer system 130. The second fee rate is charged to the merchant by the payee financial institution computer system 130 exchange for processing a payment to the merchant, including delivering the payment amount to the merchant (e.g., depositing the payment amount in an account of the merchant) within a second time period. In an example embodiment, the second fee rate is greater than the first fee rate and the second time period is less than the first time period. In this embodiment, the merchant is charged a greater fee rate (i.e., the second fee rate) to guarantee payment within a shorter time period (i.e., the second time period). For example, the payment amount may be provided to the merchant on a same day basis (i.e., the amounts owed may be deposited into the merchant's account on the same day the purchase transaction occurred) when the second fee rate is selected. As other examples, the second time period may be 4 hours or less (i.e., from when the transaction occurred), 2 hours or less, 1 hour or less, substantially instantaneously, and so on. In some embodiments, multiple time period options are provided (other than the standard processing time period) to the merchant, along with fee rate options that increase as the time period shortens. In one embodiment, the fee rates increase at a non-linear (e.g., exponential) rate, such that the merchant is charged a premium fee rate for payment within a shorter time period (e.g., within one minute, substantially instantaneously, prior to receiving funds or authorization from the payer financial institution, etc.).

The first fee rate may be determined by the payee financial institution computer system 130 based on the first time period and other information related to the payment. The second fee rate may be determined by the payee financial institution computer system 130 based on the second time period and other information related to the payment. The fee rates may be specified as a percentage of the transaction, a specific dollar amount, or in another manner. The payee financial institution computer system 130 may generate any number of fee rates based on a guaranteed processing time (e.g., time between when the payment information is sent to the payee financial institution computer system 130 and the funds are deposited in an account of the merchant) for the payment. Each time a fee rate is generated, the payee financial institution computer system 130 may send another offer to the merchant computer system 150 with each of the selectable fee rates.

At 306, a selection of an fee rate is received from the merchant computer system 150 by the payee financial institution computer system 130. The merchant computer system 150 may select any of the fee rates provided by the payee financial institution computer system 130. The selected fee rate may be applied to future payments processed by the payee financial institution computer system 130 for the merchant computer system 150. The fee rates may also be selected and/or determined on a transaction-by-transaction basis.

At 308, the payment is processed by the payee financial institution computer system 130 based on the selected fee rate, including processing the payment within the processing time guaranteed by the selected fee rate. For instance, if the second fee rate is selected by the merchant computer system 150, the payee financial institution computer system 130 processes the payment according to the terms of the second fee rate, which includes processing the payment (e.g., depositing any funds associated with the payment in an account of the merchant computer system 150) within the second time period. At 310, the payee financial institution computer system 130 receives the fee associated with the selected fee rate from the merchant computer system 150. The fee may be received from the merchant computer system 150, for example, by deducting the fee from the amount deposited into the merchant account. The fee may also be separately received from the merchant (e.g., prior to processing the payment, after the payment has been processed, in batches after a period of time or number of transactions, etc.).

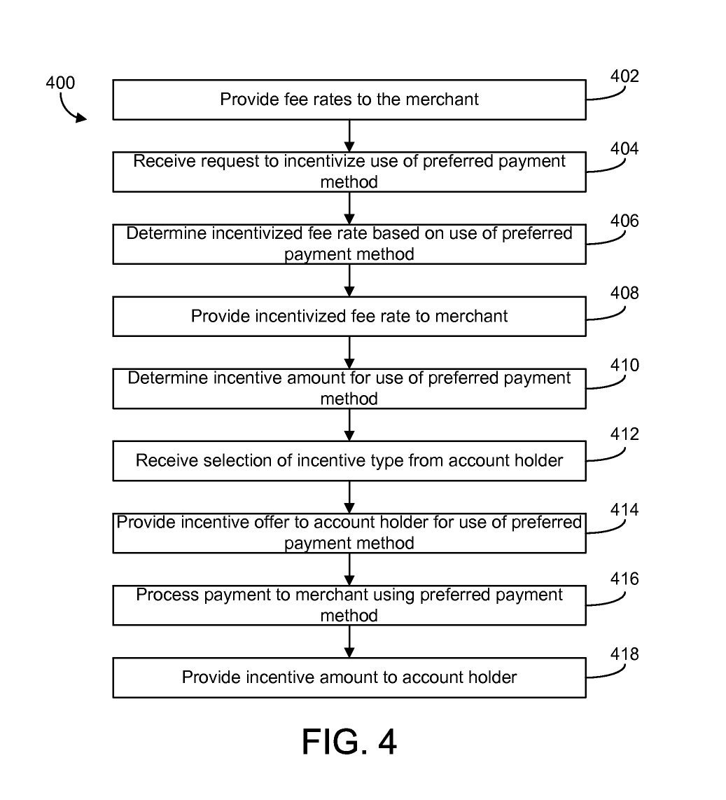

Referring now to FIG. 4, a process 400 is shown for determining variable fee rates for processing a payment to a merchant from an account holder, according to an example embodiment. The process 400 may be used to incentivize utilization of a particular payment method by the account holder. In an example embodiment, the process 400 is performed by the payee financial institution computer system 130.

At 402, two or more variable fee rates for processing a payment to the merchant are provided to the merchant computer system 150. The fee rates may differ based on the payment method utilized by the account holder. In an example embodiment, the payee financial institution computer system 130 provides at least a first fee rate (e.g., first merchant discount rate) for processing the payment when received via a first payment method (e.g., an ACH transaction), and a second fee rate (e.g., second merchant discount rate) for processing the payment when received via a second payment method (e.g., a debit card transaction). For example, the payee financial institution computer system 130 may provide a first fee rate as being $0.25 per transaction (e.g., for processing the payment when received as an ACH transaction), and a second fee rate as being $0.50 per transaction (e.g., for processing the payment when received as a debit card transaction). In this embodiment, the payee financial institution computer system 130 may also provide an additional fee rate for each payment method available to the account holder at the merchant.

At 404, a request is received by the payee financial institution computer system 130 via the merchant computer system 150 to incentivize the account holder to use a preferred payment method (e.g., the first payment method, an ACH transaction) to make the payment. For instance, the merchant computer system 150 may request that the preferred payment method (i.e., preferred from the perspective of the merchant) be incentivized over another payment method having a higher fee rate in order to lower transactional costs to the merchant. In one embodiment, the request is received after the initial fee rates are provided to the merchant computer system 150 (e.g., where the incentivized fee rate may be determined well in advance for transactions carried out over the next days/weeks/months). In another embodiment, the request is received prior to providing the initial fee rates to the merchant computer system 150 (e.g., where the incentivized fee rate is determined on a transaction-by-transaction basis).

At 406, the payee financial institution computer system 130 determines a third fee rate (e.g., an incentivized fee rate, a third merchant discount rate) for processing a payment to the merchant using the preferred payment method. The third fee rate is based on the initial fee rate for the preferred payment method (e.g., the first fee rate), but includes an additional surcharge. At least a portion of the surcharge may be provided to the account holder to incentivize use of the preferred payment method. In an example embodiment, the third fee rate is greater than the first fee rate for the preferred payment method (e.g., an ACH transaction), but less than the second fee rate for a less-preferred payment method (e.g., a debit card transaction). Based on the fee rates provided in the above example, for instance, the payee financial institution computer system 130 may determine a third (i.e., incentivized) fee rate of $0.40 per ACH transaction (or another amount, e.g., that is greater than $0.25 and less than $0.50). As part of the third fee rate, the payee financial institution computer system 130 transfers at least a portion of the difference in value (e.g., between the first fee rate and the third fee rate) to the account holder as an incentive for use of the preferred payment method.

In various embodiments, other variable fee rates may be determined (e.g., by the payee financial institution computer system 130, by the payer financial institution computer system 110) based on any number of factors related to the payment, including the payment method, the parties to the transaction, the expected processing time, the amount of the payment, and any other factors related to a cost or benefit received at the merchant, the payee financial institution, the account holder, or other entity as a result of the payment. For instance, an incentivized fee rate may be provided in a similar manner in order to incentivize providing data related to the transaction or the parties involved. The variable fee rates may be provided as a single fee, as a schedule of fees (e.g., for different transaction amounts, for different transaction parameters, etc.), or in another manner. The resulting fees are intended to be collected by the payee financial institution computer system 130 upon processing the associated payment.

At 408, the payee financial institution computer system 130 provides the fee rate for the preferred payment method (i.e., the third fee rate) to the merchant computer system 150. The third fee rate may also be provided initially with any other fee rates. The payee financial institution computer system 130 may also provide an indication to the merchant computer system 150 that the third fee rate includes an additional amount (e.g., an incentive amount) that will be provided to the account holder when the preferred payment method is utilized (i.e., to provide an incentive to the account holder). In an example embodiment, the merchant computer system 150 may select either of the initial (first) fee rate (e.g., $0.25 per transaction) and the incentivized (third) fee rate (e.g., $0.40 per transaction) as the rate for processing a payment received via the preferred payment method. Selection of a particular fee rate by the merchant computer system 150 may establish a default fee rate setting for processing payments to the merchant computer system 150 via the associated payment method. For instance, selection of the incentivized fee rate by the merchant computer system 150 may establish that any future payments to the merchant computer system 150 via the preferred payment method that are processed by the payee financial institution computer system 130 are subject to the incentivized fee rate.

At 410, the payee financial institution computer system 130 determines an incentive amount for incentivizing the account holder to use the preferred payment method. The incentive amount may be based on the surcharge (i.e., the additional amount) applied to the fee rate of the preferred payment method. For instance, the incentive amount may be $0.15 (i.e., the difference between $0.40 and $0.25) in the present example. The incentive amount may also be a portion of the surcharge amount. In other embodiments, the incentive amount may be greater than the additional amount paid by the merchant. For instance, the payee financial institution computer system 130 may receive an additional benefit when the preferred payment method is utilized by the account holder. The payee financial institution computer system 130 may then provide a portion of this additional benefit to the account holder along with any portion of the additional amount paid by the merchant. The incentive amount may also be based on characteristics of the account holder and/or the payment account, including the number of transactions by the account holder within a specified time period, membership in a rewards program, user preferences, and the like.

At 412, selection of an incentive type is received from the account holder (e.g., from the account holder computing device 140). For instance, the account holder may provide preferences regarding user rewards or incentives to the payer financial institution computer system 110 when opening the payment account. The preferences may be provided to the payee financial institution computer system 130 upon request. One or more incentive options may also be provided to the account holder for selection when the incentivized fee rate (i.e., the third fee rate) is selected by the merchant computer system 150. The available incentive types may be a cash payment related to the incentive amount, or any type of user rewards such as cash back, loyalty points, discounts, promotions, and other offers having value to the account holder. The incentive type may also be determined (e.g., by the payee financial institution computer system 130, by the payer financial institution computer system 110, etc.) based on a stored profile of the account holder, which may include stored preferences and past transactions of the account holder.

At 414, an incentive offer is provided to the account holder based on the incentive type. The value of the incentive offer is based at least in part on the incentive amount. In an example embodiment, the value of the incentive offer per transaction is approximately equal to the incentive amount per transaction. The incentive offer may be redeemable by the account holder upon use of the preferred payment method to make a payment to the merchant computer system 150.

At 416, the payment to the merchant using the preferred payment method is processed by the payee financial institution computer system 130. Processing the payment may include authorizing the payment based on payment information provided to the payee financial institution computer system 130. For instance, the payment information may be used to verify that the payment was received from the account holder (e.g., the account holder computing device 140) having the selected payment account and using the preferred payment method. In an example embodiment, the payment is processed by the payee financial institution computer system 130 in exchange for receipt of the associated fee rate (i.e., the merchant discount rate) from the merchant. The fee rate may be a percentage of the payment amount and/or a flat fee associated with the transaction. The fee rate may include an additional (e.g., surcharge) amount which may be passed on, at least in part, to the account holder as an incentive for using the preferred payment method. In one embodiment, the payee financial institution computer system 130 processes the payment only after receiving the determined fee.

At 418, the incentive amount is provided to the account holder. The incentive amount is based on the surcharge amount of the third fee rate. The incentive amount is provided to the account holder based on use of the preferred payment method to make the payment to the merchant. Use of the preferred payment method, for instance, may constitute acceptance of an incentive offer. The incentive amount may be determined by the payee financial institution computer system 130 based on any number of factors, including the incentive offer, the payment amount, the payment method, or any other factors described herein and related to the account holder, the merchant, the payer financial institution computer system 110, and/or the payee financial institution computer system 130.

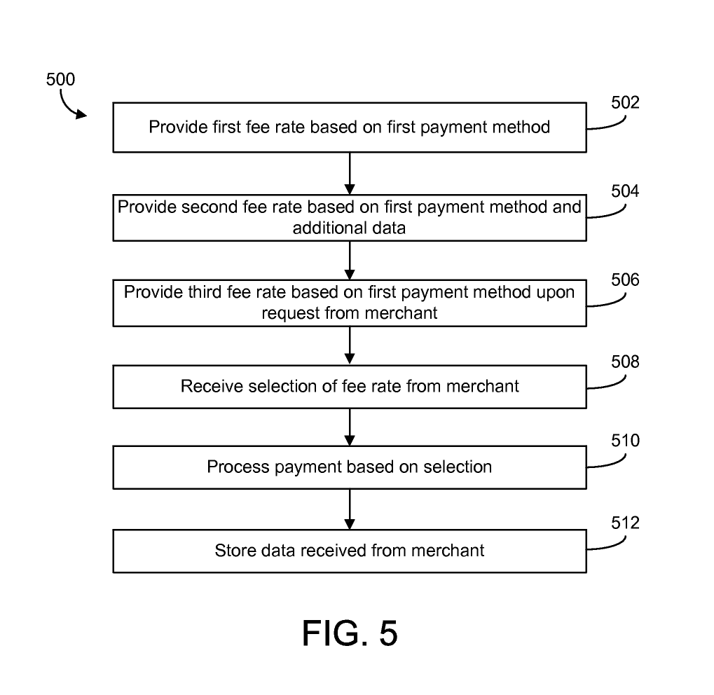

Referring now to FIG. 5, a process 500 is shown for determining variable fee rates for processing a payment to a merchant from an account holder, according to an example embodiment. The process 500 may be utilized to generate variable fee rates based on a level of information provided by the merchant computer system 150 in exchange for processing the payment. In an example embodiment, the process 500 is performed by the payee financial institution computer system 130.

The process 500 may include providing variable fee rates to the merchant computer system 150. The variable fee rates may include rates based on any number of factors described herein, including the payment method and the parties to the transaction. At 502, for instance, a first fee rate for processing a payment to the merchant using a first payment method is provided to the merchant computer system 150. At 504, a second fee rate (i.e., an incentivized fee rate) for processing a payment to the merchant using the first payment method is provided to the merchant computer system 150. In an example embodiment, the second fee rate is less than the first fee rate, but requires that the merchant computer system 150 provide additional data (i.e., more data than is associated with the first fee rate) to the payee financial institution computer system 130 in exchange for processing the payment. The fee rates may be provided to the merchant computer system 150 as an offer. The offer may include a stipulation that the second fee rate applies only when the additional information is provided by the merchant computer system 150. The second fee rate may be determined by a processing entity (e.g., by the payee financial institution computer system 130) based on the value of the additional data to the recipient of the data, which may include any parties to the transaction described herein. For instance, the second fee rate may be determined by the payee financial institution computer system 130 based on the first fee rate and the value of the additional information to the payee financial institution computer system 130 (or another recipient). In one embodiment, the second fee rate is equal to the value of the first fee rate, but discounted based on the value of the additional data provided by the merchant computer system 150.

The variable fee rates may also be determined based on any number of factors related to the payment, including the payment method, the parties to the transaction, the expected processing time, and the amount of the payment. In an example embodiment, the only differentiating variable between the first and second fee rates is the amount of information provided by the merchant computer system 150 in exchange for processing the payment. The second fee rate is intended to be collected by the payee financial institution computer system 130 via the merchant computer system 150 upon processing the associated payment. As described above, the fee rate may be based on (and include) any number of processing and other fees charged by the payer financial institution computer system 110, the payee financial institution computer system 130, and/or any other entities required to process the transaction.

At 506, an additional offer may be provided to the merchant computer system 150 by the payee financial institution computer system 130. The additional offer may include the second fee rate. For instance, the merchant may be provided initially with other fee rates based on other payment methods, but only the first fee rate for payments using the first payment method. The second fee rate may be determined and provided upon request from the merchant computer system 150 to receive a lower rate in exchange for additional information. The second fee rate may also be provided initially with any other available fee rates.

At 508, a selection of one of the provided fee rates is received from the merchant computer system 150. The selection may be received by the payee financial institution computer system 130. The selection may be permanent (i.e., applying to all future payments to the merchant until another selection is made) or for a particular payment transaction. The selection may also be applicable only to transactions involving the payer (e.g., the account holder), or otherwise applicable to a payment transaction only when a stipulated factor is present.

At 510, the payment is processed by the payee financial institution computer system 130. The payee financial institution computer system 130 may receive data from the merchant computer system 150 when the payment is processed. The data received from the merchant computer system 150 may be related to the payment, including information related to the merchant computer system 150, the account holder, the payee financial institution computer system 130, or any other information that may be of value to the receiving party (e.g., the payee financial institution computer system 130) and provided by the merchant computer system 150. In an example embodiment, the additional data provided by the merchant computer system 150 may include all information within the first level of data, as well as additional data not included within the first level of data. In another embodiment, the second level of data is unrelated to the first level of data but provides greater value to the recipient than the first level of data. At 512, any data received from the merchant computer system 150 in exchange for processing the payment is stored by the recipient (e.g., the payee financial institution computer system 130).

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions. Software implementations could be accomplished with standard programming techniques with rule based logic and other logic to accomplish the various connection steps, processing steps, comparison steps and decision steps.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All implementations that come within the spirit and scope of the following claims and equivalents thereto are claimed.

What is claimed is:

1. A computer-implemented method performed by one or more processors of a payee financial institution computer system, the method comprising:
providing to a merchant computer system, by the payee financial institution computer system, a first fee rate for processing a payment to a payee from a payer, wherein the payee is a merchant, and wherein the first fee rate is contingent upon use of a first payment method by the payer to initiate the payment;
providing to the merchant computer system, by the payee financial institution computer system, a second fee rate for processing the payment, wherein the second fee rate is contingent upon use of a second payment method by the payer to initiate the payment, and wherein the second fee rate is greater than the first fee rate;
providing to the merchant computer system, by the payee financial institution computer system, a third fee rate for processing the payment, wherein the third fee rate is contingent upon use of the first payment method by the payer to initiate the payment, wherein the third fee rate is greater than the first fee rate and less than the second fee rate, and wherein the third fee rate includes an incentive amount based on the difference between the third fee rate and the first fee rate; and
based on a selection of the third fee rate by the merchant computer system, providing, by the payee financial institution computer system, an incentive offer to the payer, wherein the incentive offer is redeemable upon use of the first payment method by the payer in a payment transaction with the merchant, and wherein the value of the incentive offer is based at least in part on the incentive amount.

2. The method of claim 1, further comprising:
determining, by the payee financial institution computer system, the incentive amount based on the difference between the second fee rate and the first fee rate, wherein the incentive amount is less than the difference between the second fee rate and the first fee rate.

3. The method of claim 2, further comprising:
prior to providing the third fee rate to the merchant computer system, receiving, by the payee financial institution computer system, a request from the merchant computer system to incentivize use of the first payment method by the payer; and
based on the request, determining, by the payee financial institution computer system, the third fee rate by applying the incentive amount to the first fee rate.

4. The method of claim 3, further comprising:
prior to receiving the request, determining, by the payee financial institution computer system, the first fee rate and the second fee rate, wherein the first fee rate is determined based on a cost associated with processing a payment utilizing the first payment method, and wherein the second fee rate is determined based on a cost associated with processing a payment utilizing the second payment method; and
upon determining the first fee rate and the second fee rate, providing, by the payee financial institution computer system, an initial offer to the merchant computer system, wherein the initial offer includes the first fee rate and the second fee rate.

5. The method of claim 2, further comprising:
prior to providing the incentive offer to the payer, receiving, by the payee financial institution computer system, a selection of an incentive type from the payer; and
determining, by the payee financial institution computer system, the incentive offer based on the incentive amount and the selected incentive type.

6. The method of claim 1, further comprising:
determining, by the payee financial institution computer system, the incentive offer based on past transactions of the payer.

7. The method of claim 1, wherein the incentive amount is the difference between the third fee rate and the first fee rate, and wherein the value of the incentive offer is approximately equal to the incentive amount.

8. The method of claim 7, wherein the incentive offer includes a cash back amount approximately equal to the incentive amount.

9. The method of claim 1, further comprising:
processing, by the payee financial institution computer system, the payment to the payee based on the third fee rate; and
upon processing the payment, providing, by the payee financial institution computer system, value to the payer based on the incentive offer.

10. A computer-implemented method performed by one or more processors of a payee financial institution computer system, the method comprising:
providing to a merchant computer system, by the payee financial institution computer system, a first fee rate for processing a payment to a payee from a payer in exchange for a first level of data associated with the payment, wherein the payee is a merchant;
providing to the merchant computer system, by the payee financial institution computer system, a second fee rate for processing the payment in exchange for a second level of data associated with the payment, wherein the second level of data includes additional information not included within the first level of data;
receiving, by the payee financial institution computer system, a selection of one of the fee rates from the merchant computer system; and
processing, by the payee financial institution computer system, the payment in accordance with the selected fee rate, including receiving the level of data associated with the selected fee rate.

11. The method of claim 10, further comprising:
upon receiving a selection of the first fee rate from the merchant computer system, lowering, by the payee financial institution computer system, the second fee rate to generate a third fee rate for processing the payment in exchange for the second level of data; and
providing, by the payee financial institution computer system, the third fee rate to the merchant computer system.

12. The method of claim 10, further comprising:
storing, at the payee financial institution computer system, the data received in exchange for processing the payment.

13. The method of claim 10, further comprising:
determining, by the payee financial institution computer system, a value of the additional information within the second level of data; and
determining, by the payee financial institution computer system, the second fee rate based on the value of the additional information.

14. The method of claim 13, wherein the value of the additional information is approximately equal to the difference between the second fee rate and the first fee rate.

15. A computer-implemented method performed by one or more processors of a payee financial institution computer system, the method comprising:
providing to a merchant computer system, by the payee financial institution computer system, a first fee rate for processing a payment to a payee from a payer, wherein the payee is a merchant, and wherein the first fee rate is contingent upon use of a first payment method by the payer to initiate the payment;
providing to the merchant computer system, by the payee financial institution computer system, a second fee rate for processing the payment, wherein the second fee rate is contingent upon use of the first payment method by the payer to initiate the payment, and wherein the second fee rate includes an incentive amount that is approximately equal to the difference between the second fee rate and the first fee rate;
receiving, by the payee financial institution computer system, a selection of the second fee rate from the merchant computer system; and
based on the selection, providing, by the payee financial institution computer system, an incentive offer to the payer, wherein the incentive offer is redeemable upon use of the first payment method by the payer to initiate the payment, and wherein the value of the incentive offer is based at least in part on the incentive amount.

16. The method of claim 15, further comprising:
providing to the merchant computer system, by the payee financial institution computer system, a third fee rate for processing the payment, wherein the third fee rate is contingent upon use of a second payment method by the payer to initiate the payment, and wherein the third fee rate is greater than each of the first and second fee rates.

17. The method of claim 16, further comprising:
determining, by the payee financial institution computer system, the incentive amount based on the difference between the third fee rate and the first fee rate.

18. The method of claim 15, further comprising:
prior to providing the second fee rate, receiving, by the payee financial institution computer system, a request from the merchant computer system to incentivize use of the first payment method by the payer.

19. The method of claim 15, wherein the incentive amount is the difference between the second fee rate and the first fee rate, and wherein the value of the incentive offer is approximately equal to the incentive amount.

20. The method of claim 15, further comprising:
processing, by the payee financial institution computer system, the payment to the merchant, including depositing the payment from a payment account of the payer into an account held by the merchant; and
upon processing the payment, providing, by the payee financial institution computer system, an incentive to the payer based on the incentive offer.

21. A computer-implemented method performed by one or more processors of a payee financial institution computer system, the method comprising:
providing to a merchant computer system, by the payee financial institution computer system, a first fee rate for processing a payment to a payee from a payer, wherein the payee is a merchant, and wherein selection of the first fee rate guarantees deposit of the payment from a payment account of the payer to an account of the merchant within a first time period;
providing to the merchant computer system, by the payee financial institution computer system, a second fee rate for processing the payment to the payee from the payer, wherein selection of the second fee rate guarantees deposit of the payment to the account of the merchant within a second time period, wherein the second time period is less than the first time period, and wherein the second fee rate is greater than the first fee rate;
receiving, by the payee financial institution computer system, a selection of one of the fee rates from the merchant computer system; and
processing, by the payee financial institution computer system, the payment in accordance with the selected fee rate.

22. The method of claim 21, further comprising:
prior to providing the second fee rate, receiving, by the payee financial institution computer system, a request from the merchant computer system to deposit the payment to the account of the merchant within the second time period; and
determining, by the payee financial institution computer system, the second fee rate based on the request to deposit the payment within the second time period.

23. The method of claim 21, further comprising:
determining, by the payee financial institution computer system, a fee for processing the payment based on the selected fee rate; and
receiving, by the payee financial institution computer system, the fee from the merchant upon processing the payment.

24. The method of claim 23, wherein processing the payment includes depositing the payment within the account of the merchant, and wherein the fee is received by deducting the fee from the payment prior to depositing the payment.

25. The method of claim 21, further comprising:
upon providing the first and second fee rates, receiving, by the payee financial institution computer system, a request from the merchant computer system to process the payment, including to deposit the payment to the account of the merchant within a third time period, wherein the third time period is less than each of the second time period and the first time period; and
providing to the merchant computer system, by the payee financial institution computer system, a third fee rate for processing the payment to the payee from the payer, wherein selection of the third fee rate guarantees deposit of the payment into the account of the merchant within the third time period.
